(19) United States
(12) Patent Application Publication
(10) Pub. No.: US 2023/0259777 A1
(43) Pub. Date: Aug. 17, 2023

(54) TRANSMISSION APPARATUS, TRANSMISSION METHOD, CONTROL CIRCUIT, AND STORAGE MEDIUM

(71) Applicant: Mitsubishi Electric Corporation, Tokyo (JP)

(72) Inventor: Manabu TAKAGI, Tokyo (JP)

(73) Assignee: Mitsubishi Electric Corporation, Tokyo (JP)

(21) Appl. No.: 18/300,801

(22) Filed: Apr. 14, 2023

Related U.S. Application Data
(63) Continuation of application No. PCT/JP2020/047201, filed on Dec. 17, 2020.

(51) Int. Cl. G06N 3/082; H04B 1/707

(52) U.S. Cl. CPC G06N 3/082; H04B 1/707

(57) ABSTRACT

A transmission apparatus includes a multiplex signal generation unit that generates a multiplex signal based on multiplexed data into which two or more pieces of data are multiplexed, and a multiplexing processing unit that generates the multiplexed data by multiplexing the pieces of data using a neural network whose parameters have been adjusted based on constraint conditions defined by the amplitude of the multiplex signal and the phase difference among the pieces of data included in the multiplex signal. The neural network has undergone pruning based on updates of parameters and a multiplex signal generated based on the multiplexed data generated using the updated parameters.

### CROSS-REFERENCE TO RELATED APPLICATION

This application is a continuation application of International Application PCT/JP2020/047201, filed on Dec. 17, 2020, and designating the U.S., the entire contents of which are incorporated herein by reference.

### BACKGROUND OF THE INVENTION

### 1. Field of the Invention

The present disclosure relates to a transmission apparatus, a transmission method, a control circuit, and a storage medium for multiplexing and transmitting signals.

### 2. Description of the Related Art

There has been a communication system in which a transmission apparatus multiplexes and transmits signals that have undergone spread processing using a spreading sequence, and a reception apparatus despreads the received signals to obtain the original signal. This technique is used in, for example, transmission apparatuses installed in a satellite that transmits a positioning signal and the like.

For satellite communication systems, downsizing and lower power consumption of satellites are important challenges. To solve the challenges, it is effective to multiplex a plurality of signals, amplify the resultant multiplex signal by a common amplifier, and transmit the amplified signal from an antenna. Amplifier efficiency increases with increase in signal level of an input signal, and becomes a maximum when the amplifier reaches or significantly approaches saturation. However, at an operating point near the saturation point, the saturation of the amplifier causes clipping of a signal waveform, and greatly degrades linearity. Therefore, in order to use the amplifier to amplify a multiplex signal into which two or more signals have been multiplexed, it is required to keep the peak-to-average power ratio (PAPR) of a transmission signal of the multiplex signal low.

As the digitalization of satellite-mounted systems proceeds, it can be considered that a signal generation unit that has been configured with an analog circuit so far is configured with a digital circuit. In this case, possible scenarios include a scenario to change signal specification in the process of actual operation. To this end, multiplexing circuits for multiplexing signals are required to have high versatility such that the circuits can be adapted to these scenarios. For example, when the transmission power ratio or the modulation scheme itself of signals to be multiplexed is changed after the satellite is launched, operating parameters of the multiplexing circuit need to be reset according to the changed transmission power ratio or modulation scheme of the signals to be multiplexed.

Non Patent Literature 1, ‘M. Kim, W. Lee, D. H. Cho, “A Novel PAPR Reduction Scheme for OFDM System Based on Deep Learning”, IEEE COMMUNICATIONS LETTERS, VOL. 22, NO. 3, pp. 510-513, March 2018’ relates to an Orthogonal Frequency Division Multiplexing (OFDM) modulation scheme, which describes a method of evaluating and determining operating parameters of a multiplexing circuit that multiplexes subcarrier signals, using machine learning. According to the above Non Patent Literature 1, the multiplexing circuit is configured with a neural network (NN). Then, by performing learning of the NN so as to minimize the sum of the PAPR and the bit error ratio (BER) that are evaluation functions, OFDM signals having low PAPR characteristics and good BER characteristics can be obtained in various transmission paths. The technique described in the above Non Patent Literature 1 is applied to OFDM modulation, but is also applicable to any systems for multiplexing a plurality of signals.

The above conventional technique, which can keep the PAPR of multiplexed signals low, thus allows amplification near the saturation point where the amplifier maximum efficiency can be obtained. In addition, since the multiplexing circuit is configured with the NN, it is possible to adapt to a scenario to change signal specification by learning the NN again with a multiplexing condition, for example, the signal power ratio or the modulation scheme changed. However, since the multiplexing circuit is configured with the NN, a problem arises in that the amount of calculation such as integration increases with higher density of the NN or with a larger number of layers of which the NN is composed. As a measure against this problem, there is a method called pruning in which the amount of calculation is reduced by disconnecting networks having lower importance of networks that have been subjected to learning once. However, it is difficult to determine which is a connection of a network having lower importance, that is, which network is to be disconnected so as to enable a reduction in performance degradation due to the pruning to be minimized.

The present disclosure has been made in view of the above circumstances, and an object thereof is to provide a transmission apparatus capable of minimizing performance degradation in a case where the amount of calculation of a neural network used for signal multiplexing is reduced by pruning.

### SUMMARY OF THE INVENTION

In order to solve the above problems and achieve the object, the present disclosure provides a transmission apparatus, comprising: a multiplex signal generator to generate a multiplex signal based on multiplexed data into which two or more pieces of data are multiplexed; and a multiplexing processor to generate the multiplexed data by multiplexing the pieces of data using a neural network whose parameters have been adjusted based on constraint conditions defined by an amplitude of the multiplex signal and a phase difference among the two or more pieces of data included in the multiplex signal, wherein the neural network has undergone pruning based on updates of parameters and a multiplex signal generated based on the multiplexed data generated using the parameters updated.

### BRIEF DESCRIPTION OF THE DRAWINGS

FIG. 1 is a diagram illustrating a functional configuration example of a transmission apparatus according to a first embodiment;

FIG. 2 is a diagram illustrating a first configuration example of hardware for implementing the transmission apparatus according to the first embodiment;

FIG. 3 is a diagram illustrating a second configuration example of hardware for implementing the transmission apparatus according to the first embodiment;

FIG. 4 is a diagram illustrating a processing unit that operates at the time of a learning step of the transmission apparatus according to the first embodiment;

FIG. 5 is a flowchart illustrating an example of operation when the transmission apparatus according to the first embodiment performs the learning step;

FIG. 6 is a diagram illustrating an example of a plurality of signals inputted to the transmission apparatus according to the first embodiment;

FIG. 7 is a diagram illustrating possible patterns of the signals to be multiplexed by the transmission apparatus according to the first embodiment;

FIG. 8 is a diagram illustrating a configuration example of a neural network applied to a multiplexing processing unit of the transmission apparatus according to the first embodiment;

FIG. 9 is a first graph for explaining a method of calculating an evaluation function by an evaluation function calculation unit according to the first embodiment;

FIG. 10 is a second graph for explaining a method of calculating an evaluation function by the evaluation function calculation unit according to the first embodiment;

FIG. 11 is a diagram illustrating a processing unit that operates at the time of a pruning step of the transmission apparatus according to the first embodiment;

FIG. 12 is a flowchart illustrating an example of operation when the transmission apparatus according to the first embodiment performs the pruning step;

FIG. 13 is a diagram illustrating a processing unit that operates at the time of an operating step of the transmission apparatus according to the first embodiment;

FIG. 14 is a flowchart illustrating an example of operation when the transmission apparatus according to the first embodiment performs the operating step;

FIG. 15 is a diagram illustrating a functional configuration example of a transmission apparatus and a learning apparatus according to a second embodiment;

FIG. 16 is a flowchart illustrating an example of operation when the transmission apparatus and the learning apparatus according to the second embodiment perform a learning step; and

FIG. 17 is a flowchart illustrating an example of operation when the transmission apparatus and the learning apparatus according to the second embodiment perform a pruning step.

### DETAILED DESCRIPTION OF THE PREFERRED EMBODIMENTS

Hereinafter, a transmission apparatus, a transmission method, a control circuit, and a storage medium according to embodiments of the present disclosure will be described in detail with reference to the drawings.

### First Embodiment

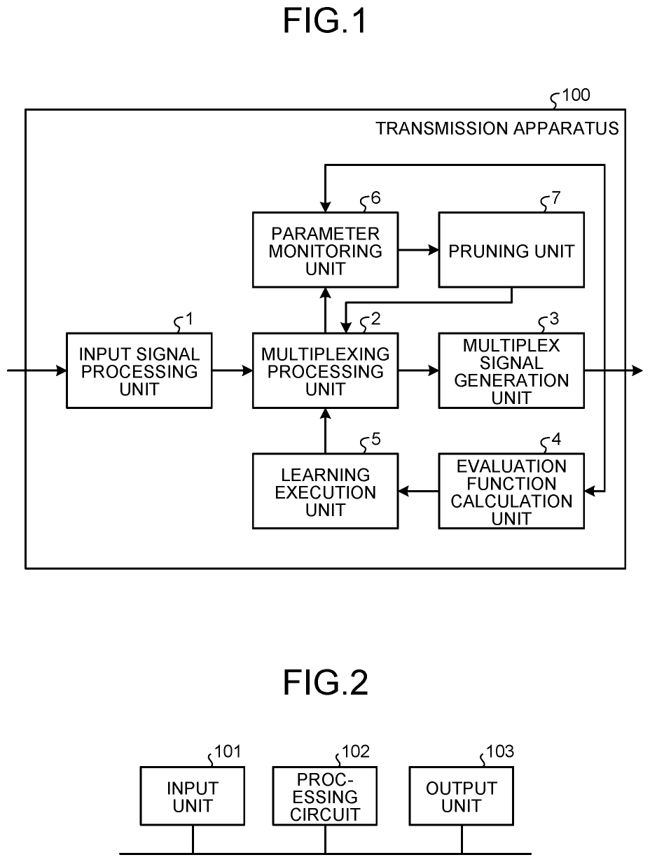

FIG. 1 is a diagram illustrating a functional configuration example of a transmission apparatus 100 according to a first embodiment. The transmission apparatus 100 receives, as input, two or more pieces of spread data that have been obtained by spreading data acquired from the outside, and obtains a multiplex signal that satisfies a constraint condition that has been set. Here, the two or more pieces of spread data that are to be input signals are each generated by, for example, spreading message data or data of a fixed repetitive pattern. In the present embodiment, a signal transmitted by the transmission apparatus 100 is “0” or “1”, but a numerical value other than “0” and “1” may be transmitted. The transmission apparatus 100 is installed in, for example, a satellite that constitutes a satellite communication system.

As illustrated in FIG. 1, the transmission apparatus 100 includes an input signal processing unit 1, a multiplexing processing unit or processor 2, a multiplex signal generation unit or generator 3, an evaluation function calculation unit or calculator 4, a learning execution unit or circuit 5, a parameter monitoring unit or monitor 6, and a pruning unit or circuit 7.

The input signal processing unit 1 adjusts each of the symbol rates of two or more pieces of spread data inputted from the outside to the least common multiple of the symbol rates of the spread data, and outputs the data obtained by the adjustment to the multiplexing processing unit 2.

The multiplexing processing unit 2 is configured with a neural network (hereinafter, referred to as the NN). The multiplexing processing unit 2 receives the two or more pieces of spread data whose symbol rates have been adjusted by the input signal processing unit 1 as inputs for the NN, and outputs results outputted according to parameters of the NN to the multiplex signal generation unit 3. That is, the multiplexing processing unit 2 multiplexes a plurality of pieces of spread data whose symbol rates have been adjusted, by using the NN, and generates multiplexed data that is the results of multiplexing the plurality of pieces of spread data.

The multiplex signal generation unit 3 performs mapping processing to map the multiplexing results inputted from the multiplexing processing unit 2 on the in-phase quadrature (IQ) plane to generate a multiplex signal. The multiplex signal generated by the multiplex signal generation unit 3 is transmitted from the transmission apparatus 100 to a reception apparatus (not illustrated). In addition, the multiplex signal is inputted to the evaluation function calculation unit 4 and the parameter monitoring unit 6.

For the multiplex signal inputted from the multiplex signal generation unit 3, the evaluation function calculation unit 4 calculates predetermined evaluation functions, that is, the PAPR and BER characteristics of the multiplex signal, for example, and outputs the result of calculating the evaluation functions to the learning execution unit 5.

The learning execution unit 5 updates the parameters of the NN (hereinafter, sometimes referred to as the NN parameters) of the multiplexing processing unit 2, based on the result of the calculation of the evaluation functions obtained from the evaluation function calculation unit 4.

The parameter monitoring unit 6 monitors updates of the NN parameters made by the learning execution unit 5 and a multiplex signal generated by the multiplex signal generation unit 3, and determines how the multiplex signal generated by the multiplex signal generation unit 3 changes, that is, the effects of updating of the NN parameters on the multiplex signal, when the learning execution unit 5 updates the NN parameters of the multiplexing processing unit 2. Specifically, the parameter monitoring unit 6 determines which of the frequency, phase, and amplitude of the multiplex signal each NN parameter relates to, on the basis of monitoring results.

The pruning unit 7 performs pruning processing on the NN of the multiplexing processing unit 2. Specifically, the pruning unit 7 determines which network of the NN is to be preferentially left at the time of the pruning processing on the NN of the multiplexing processing unit 2, based on the relationships between the NN parameters and the frequency, phase, and amplitude of the multiplex signal, determined by the parameter monitoring unit 6, and performs the pruning processing to disconnect a network or networks thereof determined to be unnecessary.

The present embodiment provides description on the assumption that two or more pieces of spread data generated outside are inputted to the transmission apparatus 100. However, another configuration may be adopted in which processing to spread each of two or more pieces of data to generate two or more pieces of spread data is performed inside the transmitting apparatus 100. In addition, a configuration may be adopted in which processing for the input signal processing unit 1 to adjust the symbol rates is performed outside the transmission apparatus 100. That is, the configuration results in the input signal processing unit 1 being omitted, while the spread data pieces whose symbol rates have been adjusted are inputted to the transmission apparatus 100.

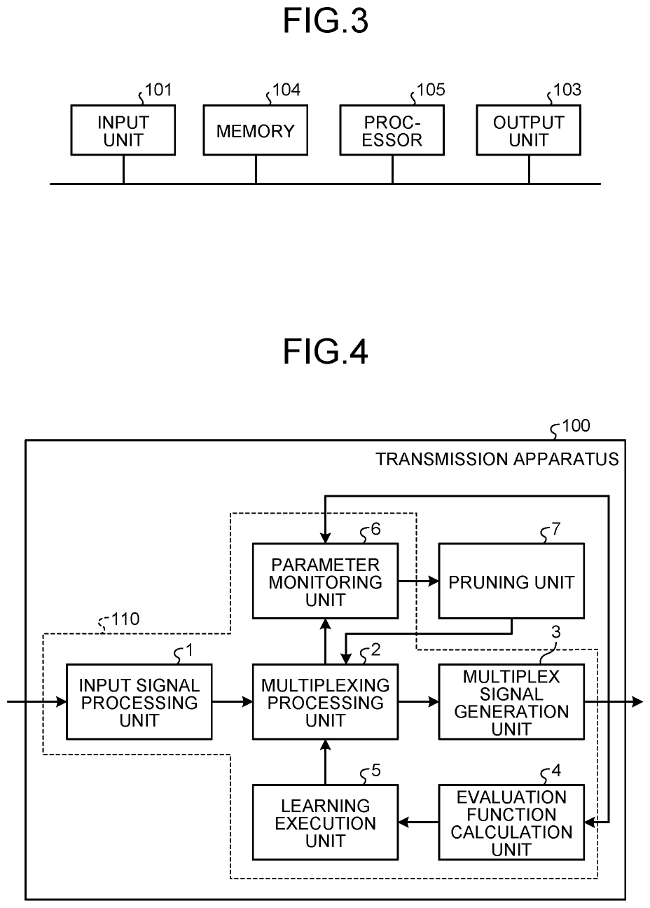

Next, hardware for implementing the transmission apparatus 100 will be described. The transmission apparatus 100 can be implemented by hardware having a configuration illustrated in FIG. 2 or FIG. 3.

FIG. 2 is a diagram illustrating a first configuration example of the hardware for implementing the transmission apparatus 100 according to the first embodiment. FIG. 3 is a diagram illustrating a second configuration example of the hardware for implementing the transmission apparatus 100 according to the first embodiment. FIG. 2 illustrates a hardware configuration when the principal parts of the transmission apparatus 100, specifically, the input signal processing unit 1, the multiplexing processing unit 2, the multiplex signal generation unit 3, the evaluation function calculation unit 4, the learning execution unit 5, the parameter monitoring unit 6, and the pruning unit 7 are implemented by a processing circuit 102 that is dedicated hardware. The processing circuit 102 is, for example, an application-specific integrated circuit (ASIC), a field programmable gate array (FPGA), or an electric circuit into which any of them are combined. In the example illustrated in FIG. 2, the input signal processing unit 1, the multiplexing processing unit 2, the multiplex signal generation unit 3, the evaluation function calculation unit 4, the learning execution unit 5, the parameter monitoring unit 6, and the pruning unit 7 are implemented by the single processing circuit 102, but the present disclosure is not limited to this example. The hardware may include a plurality of the processing circuits 102, and the input signal processing unit 1, the multiplexing processing unit 2, the multiplex signal generation unit 3, the evaluation function calculation unit 4, the learning execution unit 5, the parameter monitoring unit 6, and the pruning unit 7 may be implemented by their respective processing circuits different from each other.

An input unit 101 is an electric circuit that receives input signals to the transmission apparatus 100, that is, a plurality of pieces of spread data from the outside. An output unit 103 is an electric circuit that outputs a multiplex signal generated by the transmission apparatus 100 to the outside.

Symbol rate adjustment processing performed by the input signal processing unit 1 may be performed by the input unit 101. That is, the input unit 101 may implement the input signal processing unit 1.

FIG. 3 illustrates a hardware configuration in a case where the processing circuit 102 illustrated in FIG. 2 is implemented by a memory 104 and a processor 105, that is, a hardware configuration when the principal parts of the transmission apparatus 100 are implemented by the memory 104 and the processor 105. The memory 104 is, for example, a nonvolatile or volatile memory such as random access memory (RAM), read only memory (ROM), flash memory, erasable programmable read only memory (EPROM), or electrically erasable programmable read only memory (EEPROM) (registered trademark). The processor 105 is a central processing unit (CPU; also called a central processing device, a processing device, an arithmetic unit, a microprocessor, a microcomputer, or a digital signal processor (DSP)).

When the principal parts of the transmission apparatus 100 are implemented by the memory 104 and the processor 105, the processor 105 executes a program describing processing for the processor to operate as the input signal processing unit 1, the multiplexing processing unit 2, the multiplex signal generation unit 3, the evaluation function calculation unit 4, the learning execution unit 5, the parameter monitoring unit 6, and the pruning unit 7, thereby implementing these units. The program describing the processing for the processor to operate as the input signal processing unit 1, the multiplexing processing unit 2, the multiplex signal generation unit 3, the evaluation function calculation unit 4, the learning execution unit 5, the parameter monitoring unit 6, and the pruning unit 7 is stored in advance in the memory 104. The processor 105 reads and executes the program stored in the memory 104, thereby operating as the input signal processing unit 1, the multiplexing processing unit 2, the multiplex signal generation unit 3, the evaluation function calculation unit 4, the learning execution unit 5, the parameter monitoring unit 6, and the pruning unit 7.

Part of the input signal processing unit 1, the multiplexing processing unit 2, the multiplex signal generation unit 3, the evaluation function calculation unit 4, the learning execution unit 5, the parameter monitoring unit 6, and the pruning unit 7 may be implemented by the memory 104 and the processor 105, and the rest thereof may be implemented by dedicated hardware similar to the processing circuit 102 illustrated in FIG. 2.

The program, which is stored in the memory 104 in advance, is not limited to this manner. The program may be in the form of being provided to a user in a state of being written in a storage medium such as a compact disc (CD)-ROM or a digital versatile disc (DVD)-ROM, and installed in the memory 104 by the user.

Next, the operation of the transmission apparatus 100 will be described. The operation of the transmission apparatus 100 is divided into three steps: a learning step, a pruning step, and an operating step. The operation of each of these three steps will be described below.

<Learning Step>

First, the learning step will be described. FIG. 4 is a diagram illustrating a processing unit that operates at the time of the learning step of the transmission apparatus 100 according to the first embodiment. A learning operation block 110 composed of the units enclosed by a broken line operates at the time of the learning step.

In the learning step, the learning execution unit 5 updates the parameters of the NN of the multiplexing processing unit 2, based on a plurality of pieces of spread data outputted from the input signal processing unit 1 and the result of calculation of the evaluation functions outputted from the evaluation function calculation unit 4. The parameter monitoring unit 6 determines, from the results of the update of the NN parameters and the results of monitoring of a multiplex signal generated by the multiplex signal generation unit 3, which of the frequency, phase, or amplitude of the multiplex signal output each parameter of the NN relates to. This provides the effect that appropriate NN parameters can be learned from the plurality of pieces of spread data inputted to the multiplexing processing unit 2 and the result of the calculation of the evaluation functions obtained by the evaluation function calculation unit 4.

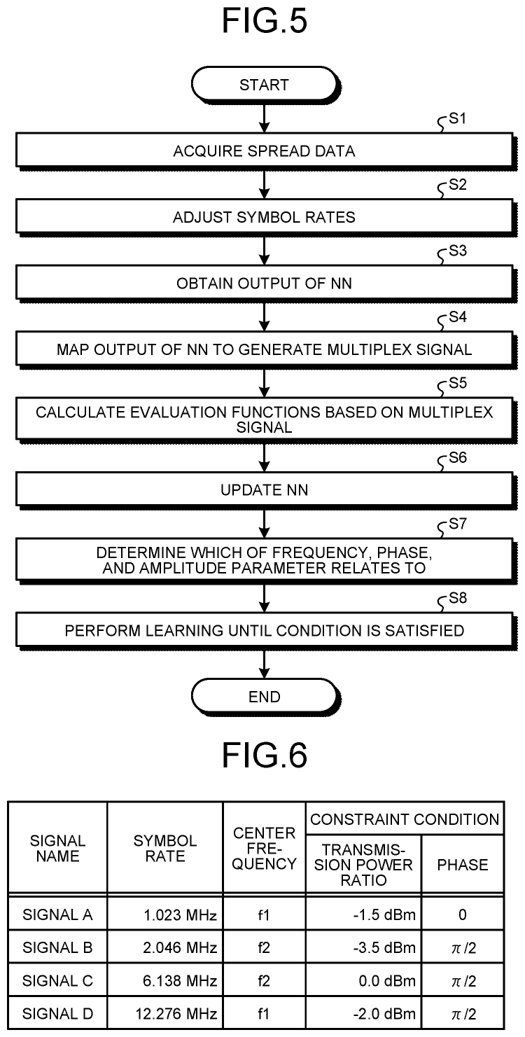

Details of the operation of the learning step will be described with reference to FIG. 5. FIG. 5 is a flowchart illustrating an example of operation when the transmission apparatus 100 according to the first embodiment performs the learning step.

In the learning step, first, the transmission apparatus 100 acquires two or more pieces of spread data (step S1). Here, by way of example, the description will be continued on the assumption that four signals, i.e., signals A to D having their respective symbol rates as illustrated in FIG. 6 are inputted to the transmission apparatus 100 from the outside. That is, the input signal processing unit 1 acquires the signals A to D. FIG. 6 is a diagram illustrating an example of a plurality of signals inputted to the transmission apparatus 100 according to the first embodiment. As illustrated in FIG. 6, the signals A to D have their respective symbol rates different from each other, and the signals A and D have a center frequency of f1, and the signals B and C have a center frequency of f2. In addition, the signals A to D have their respective constraint conditions (transmission power ratios and phases) different from each other. Although the example where the constraint conditions are represented by the transmission power ratio and the phase has been described, an element for the constraint condition is not limited to this example.

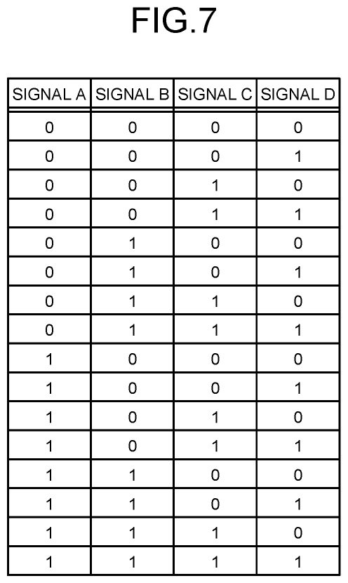

Next, the input signal processing unit 1 adjusts the symbol rates of the acquired spread data (step S2). When the four signals illustrated in FIG. 6 are multiplexed, the least common multiple of all the symbol rates is 12.276 MHz. Therefore, the input signal processing unit 1 oversamples the signal A at twelve times, the signal B at six times, and the signal C at two times to match the symbol rates of all the pieces of spread data. As a result of matching the symbol rates, if each of signals to be multiplexed can have one of M values and the number of the signals to be multiplexed is N, the number of possible values is M\hat{ }N (M^{N}). In this example, since the four signals each having one of two values are multiplexed, M=2 and N=4, and then the possible values of the four signals are any combinations in 2\hat{ }4=16 patterns as illustrated in FIG. 7. FIG. 7 is a diagram illustrating the possible patterns of the signals to be multiplexed by the transmission apparatus 100 according to the first embodiment. In a case where the symbol rates are not adjusted, and the signals are to be multiplexed with keeping the different symbol rates, this operation can be omitted.

Next, the four signals whose symbol rates have been adjusted by the input signal processing unit 1 are inputted to the multiplexing processing unit 2 to obtain the output of the NN (step S3). The output of the NN is the output of the multiplexing processing unit 2, that is, the results of multiplexing of the four signals whose symbol rates have been adjusted by the input signal processing unit 1.

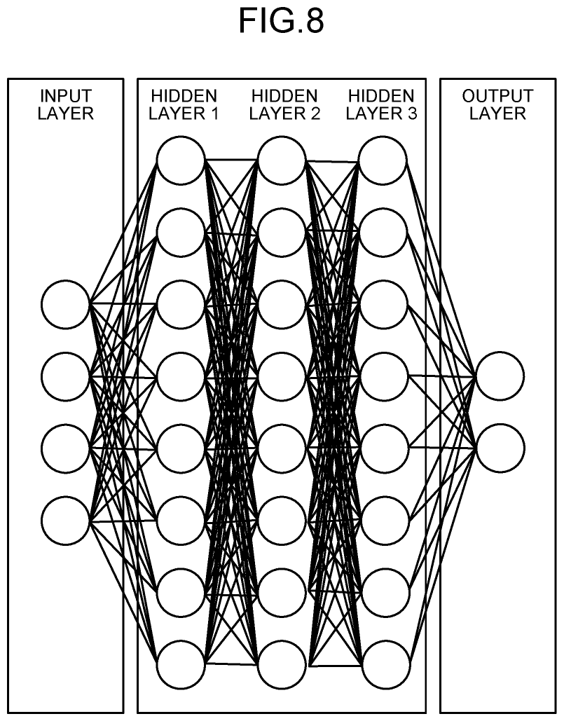

Here, the NN will be described. FIG. 8 is a diagram illustrating a configuration example of the neural network applied to the multiplexing processing unit 2 of the transmission apparatus 100 according to the first embodiment. As illustrated in FIG. 8, the NN is composed of an input layer, an arbitrary number of hidden layers that are intermediate layers, and an output layer. The input layer of the NN includes a plurality of input nodes (neurons) (four nodes in this example). The number of the hidden layers is two or more (three in this example). The output layer includes output nodes representing signal multiplexing results (two values, i.e., a real value and an imaginary value in this example). The number of layers and the number of nodes (the number of neurons) represent their respective examples. In the NN, the nodes in the input layer and the nodes in the hidden layers are fully connected (fully connected layers), and the nodes in the hidden layers and the nodes in the output layer are fully connected. There are arbitrary numbers of nodes in the input layer, the hidden layers, and the output layer, respectively. The node is a function of receiving an input and outputting a value. The input layer includes a bias node to which an independent value is inputted in addition to the input nodes. The configuration is constructed by stacking layers each having two or more nodes. A node in each layer weights the received input and converts the received input using an activation function to output the conversion result to the next layer. Examples of the activation function include a nonlinear function such as a sigmoid function and a rectified linear unit function (ReLU).

Returning to the description of the learning step, next, the multiplex signal generation unit 3 recognizes two output symbols of the NN of the multiplexing processing unit 2 as a real value and an imaginary value, and maps these values on the IQ plane also called a complex plane to generate a multiplex signal (step S4). At this time, the signal points of the multiplexed spread data outputted by the NN of the multiplexing processing unit 2 may be directly mapped, or the signal points may be mapped on a constant envelope.

Next, the evaluation function calculation unit 4 calculates the evaluation functions based on the multiplex signal generated by the multiplex signal generation unit 3 (step S5). Specifically, the evaluation function calculation unit 4 calculates the evaluation functions based on the constraint conditions imposed on the multiplex signal. The constraint conditions imposed on the multiplex signal are defined by, for example, the amplitude of the multiplex signal and the phase difference among the two or more signals included in the multiplex signal. For example, the evaluation function calculation unit 4 calculates, as an evaluation function, the distance between the signal point indicated by the multiplex signal generated by the multiplex signal generation unit 3 and a signal point indicated by a replica of the multiplex signal. In addition, the evaluation function calculation unit 4 calculates, as an evaluation function, whether the phase difference among the signals included in the multiplex signal generated by the multiplex signal generation unit 3 keeps the phase difference between the signals before being multiplexed, that is, whether the phase difference among the signals after being multiplexed keeps the phase difference among the signals before being multiplexed.

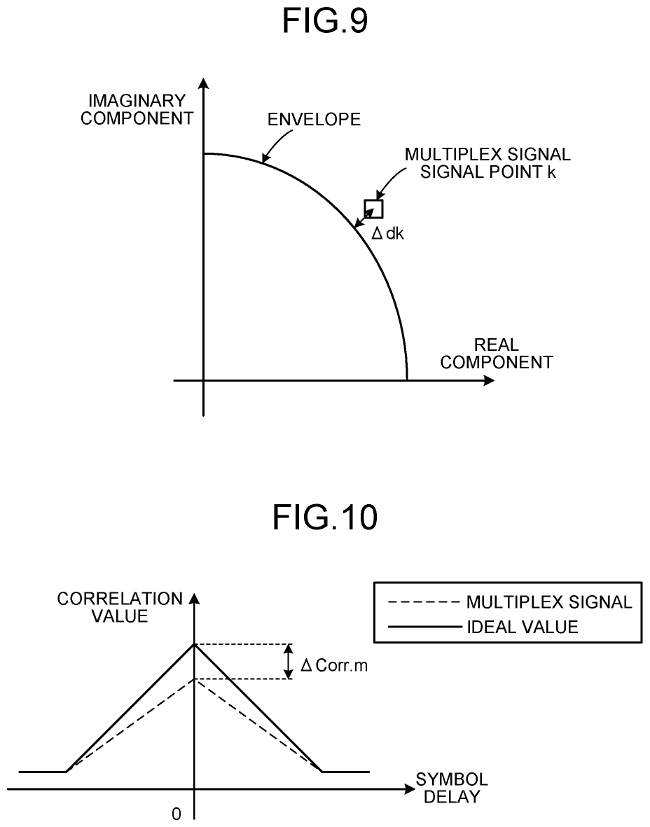

Examples of calculation of the evaluation function will be described with reference to FIGS. 9 and 10. FIG. 9 is a first diagram for explaining a method of calculating the evaluation function by the evaluation function calculation unit 4 according to the first embodiment. FIG. 10 is a second diagram for explaining a method of calculating the evaluation function by the evaluation function calculation unit 4 according to the first embodiment.

FIG. 9 illustrates a result obtained by recognizing two results outputted from the NN of the multiplexing processing unit 2 as a real component and an imaginary component, and mapping the signal point thereof. In this example, the evaluation function calculation unit 4 calculates a distance Δdk from the coordinate position of the signal point k of the multiplex signal (a square in the figure) to a target envelope (a solid line in the figure), and uses this distance as the result of calculation of the evaluation function. The evaluation function calculation unit 4 calculates Δdk for all signal points and uses the sum thereof as one of the evaluation functions. In the present embodiment, since the four signals illustrated in FIGS. 6 and 7 are multiplexed, the evaluation function calculation unit 4 calculates Δdk for each of sixteen signal points, and uses the sum thereof as one of the evaluation functions.

FIG. 10 illustrates the result of calculating the correlation between the multiplex signal and each signal obtained by shifting a replica signal of a signal “m” of the signals to be multiplexed every a predetermined number of symbols (broken line). A solid line in the figure indicates an ideal value, which is the result of calculating the correlation between the replica signals. The evaluation function calculation unit 4 calculates a difference ΔCorr.m between the peaks of two correlation values (values at a symbol delay of zero) as illustrated in FIG. 10 for all the signals to be multiplexed, in the present embodiment, the four signals A to D described above, and uses the sum of them as one of the evaluation functions.

The evaluation function calculation unit 4 sums the two evaluation functions described above with reference to FIGS. 9 and 10, and sets the resultant sum as a final evaluation function. The final evaluation function calculated by the evaluation function calculation unit 4 is represented as Err. This is expressed by a mathematical expression as an equation (1) formulated below. To increase generalization capability, the second term of the equation is multiplied by a regularization term p having a positive value. The evaluation function Err has a positive value of zero or larger. As this value of Err is smaller, the performance of the signals multiplexed by the NN is higher, and so it can be said that the performance of the multiplexing processing by the NN is better.

$$Formula 1$$

$$Err = {\sum }_{k = 0}^{K - 1} Δ dk + μ {\sum }_{m = 0}^{M - 1} Δcorr• m \qquad ( 1 )$$

Next, the learning execution unit 5 updates the NN of the multiplexing processing unit 2 (step S6). Specifically, the learning execution unit 5 performs a learning operation to update weights in each layer that are the parameters of the NN. In this learning operation, the learning execution unit 5 calculates the evaluation function represented by the equation (1), and based on that calculation, adjusts the weights in each layer of the NN. The learning operation is to solve an optimization problem that minimizes an error, that is, the evaluation function. For a solution to the optimization problem, an error back propagation algorithm is typically used. In an error back propagation algorithm, an error is propagated from the output layer of the NN to adjust the weights in each layer. Specifically, an error back propagation algorithm refers to a method of calculating the amounts of update of the weights in each layer with use of values obtained from the output layer side, and propagating the values that determine the amounts of update of the weights in each layer toward the input layer while calculating the values.

Next, the parameter monitoring unit 6 determines which parameter of the NN is changed to affect which of the frequency, phase, and amplitude of the multiplex signal (step S7). For example, the parameter monitoring unit 6 records a certain number of parameters of the NN in decreasing order from a parameter whose value has the greatest change in one learning process. The parameter monitoring unit 6 may record all the parameters. Thereafter, the parameter monitoring unit 6 calculates the amount of change in center frequency from the frequency spectra of the pre-learning and post-learning multiplex signals. The calculation of the amount of change is of a general means and will not be described here. When the amount of change in center frequency exceeds a predetermined threshold value, the top N % of the parameters of the NN with larger amounts of change are recorded as parameters affecting the frequency. Parameters with a larger amount of change in center frequency are parameters having larger effects on the frequency, and are regarded as parameters of higher importance. The parameter monitoring unit 6 performs similar processing on the phase and amplitude of the multiplex signal as well, and determines which parameter of the NN relates to which of the frequency, phase, or amplitude.

The units in the learning operation block 110 illustrated in FIG. 4 repeatedly perform the above-described operation. The units of the learning operation block 110 repeat the above-described operation to perform learning until a predetermined condition is satisfied, for example, until a condition that the number of executions of learning reaches a predetermined number of times, a condition that the result of calculation of the evaluation function obtained by the evaluation function calculation unit 4 falls below a predetermined threshold, or other condition like that is satisfied (step S8).

<Pruning Step >

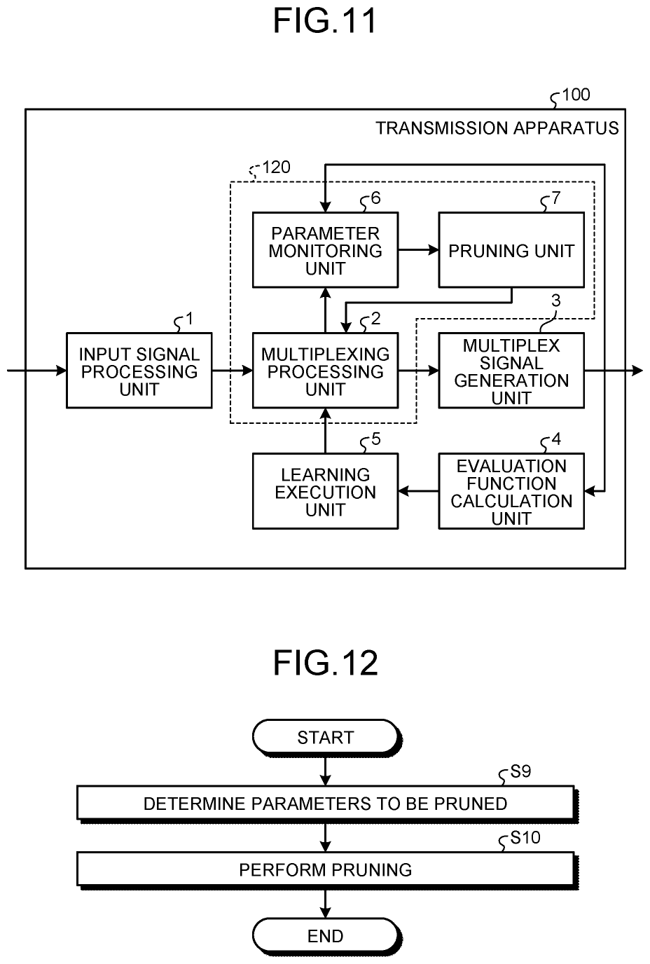

Next, the pruning step will be described. FIG. 11 is a diagram illustrating a processing unit that operates at the time of the pruning step of the transmission apparatus 100 according to the first embodiment. A pruning operation block 120 composed of the units enclosed by a broken line operates at the time of the pruning step.

In the pruning step, the pruning unit 7 determines NN parameters to be pruned according to a predetermined pruning rate, from relationships between the NN parameters of the multiplexing processing unit 2 on the one hand and the frequency, phase, and amplitude of the multiplex signal on the other hand, the relationships having been determined by the parameter monitoring unit 6. Thereafter, the pruning unit 7 performs pruning processing in which the NN parameters determined to be objects to be pruned are set to zeros. This enables NN parameters of higher importance having larger effects on each of the frequency, phase, and amplitude of the multiplex signal to be left preferentially. That is, it is possible to reduce the amount of calculation of the NN while minimizing performance degradation due to the pruning.

Details of the pruning step will be described with reference to FIG. 12. FIG. 12 is a flowchart illustrating an example of operation when the transmission apparatus 100 according to the first embodiment performs the pruning step.

In the pruning step, the pruning unit 7 first determines parameters to be pruned, on the basis of results determined by the parameter monitoring unit 6 in step S7 in the learning step described above, or specifically, results of the determination of the parameters of higher importance that have larger effects on each of the frequency, phase, and amplitude of the multiplex signal (step S9). For example, in the case of the pruning rate being 50%, the bottom 50% of the parameters in importance are determined to be objects to be pruned so as to leave the top 50% of the parameters in descending order of importance for each of the frequency, phase, and amplitude of the multiplex signal.

Next, the pruning unit 7 performs pruning in accordance with the determination results of step S9 (step S10). That is, the pruning unit 7 sets the parameters determined to be objects to be pruned in step S9, to zeros.

<Operating Step >

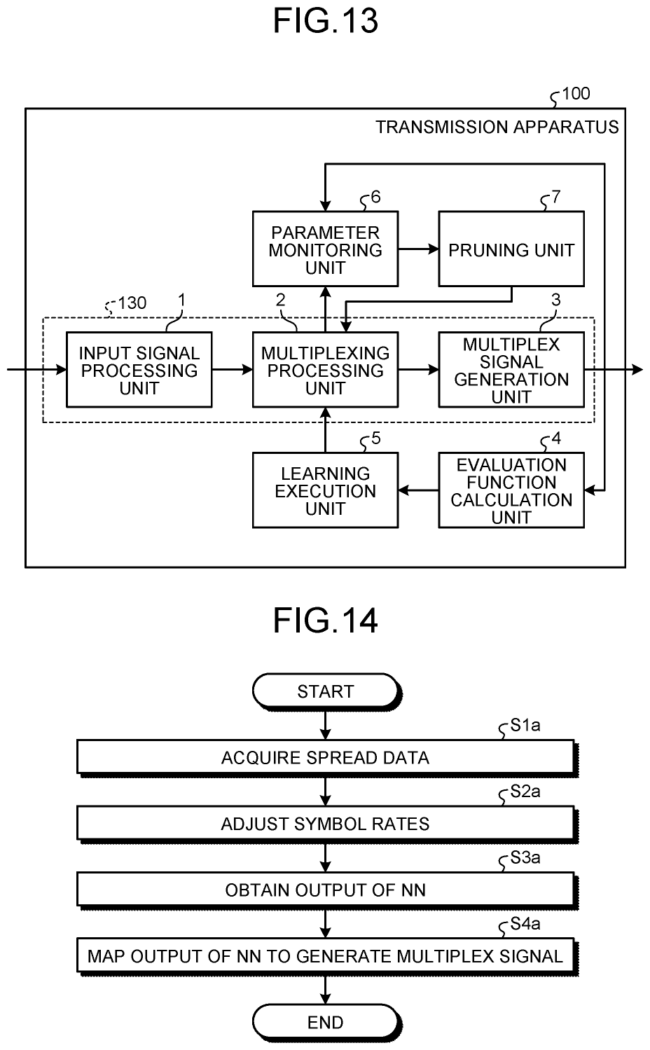

Next, the operating step will be described. FIG. 13 is a diagram illustrating a processing unit that operates at the time of the operating step of the transmission apparatus 100 according to the first embodiment. An operating operation block 130 composed of the units enclosed by a broken line operates at the time of the operating step.

In the operating step, the multiplexing processing unit 2 performs, on the spread data inputted from the input signal processing unit 1, multiplex processing using the NN optimized in the learning step and the pruning step described above. The multiplex signal generation unit 3 maps multiplexing results inputted from the multiplexing processing unit 2 on the IQ plane, and outputs the results as a multiplex signal to the outside of the transmission apparatus 100. Consequently, the multiplex signal outputted by the transmission apparatus 100 is a signal that achieves both low PAPR characteristics and good correlation characteristics at the time of despreading at a receiver.

Details of the operating step will be described with reference to FIG. 14. FIG. 14 is a flowchart illustrating an example of operation when the transmission apparatus 100 according to the first embodiment performs the operating step.

In the operating step, first, the input signal processing unit 1 acquires two or more pieces of spread data (step S1a), and adjusts the symbol rates of the acquired spread data pieces (step S2a). Next, the multiplexing processing unit 2 inputs each piece of the spread data whose symbol rates have been adjusted by the input signal processing unit 1 to the NN to obtain the output of the NN (step S3a). Next, the multiplex signal generation unit 3 maps the output of the NN of the multiplexing processing unit 2 on the IQ plane to generate a multiplex signal (step S4a). Steps S1a to S4a refer to the same processing as that of steps S1 to S4 in the above-described learning step, and thus details thereof will be omitted.

As described above, the transmission apparatus 100 according to the present embodiment learns the NN used for the signal multiplexing processing, based on the constraint condition on a multiplex signal to be generated and the evaluation functions having been set, and further determines which of the frequency, phase, or amplitude the parameter of the NN relates to and determines the importance of each parameter, and performs the pruning processing to leave parameters of higher importance. This enables performance degradation to be restrained when the amount of calculation of the NN is reduced by the pruning. That is, it is possible to generate a multiplex signal while minimizing performance degradation of the NN due to the pruning.

### Second Embodiment

The transmission apparatus 100 according to the first embodiment learns the neural network of the multiplexing processing unit 2 inside the apparatus, and after the learning, generates a multiplex signal using the learned neural network and outputs it. However, there is a possibility that computer resources of equipment in which the transmission apparatus 100 is to be incorporated are under significantly tight conditions, and learning cannot be performed onboard. In the circumstances, the present embodiment gives description for a configuration in which learning is performed in another piece of equipment, with use of computer resources of that piece of equipment, and the parameters of the neural network are updated using parameters that have been learned in that piece of equipment.

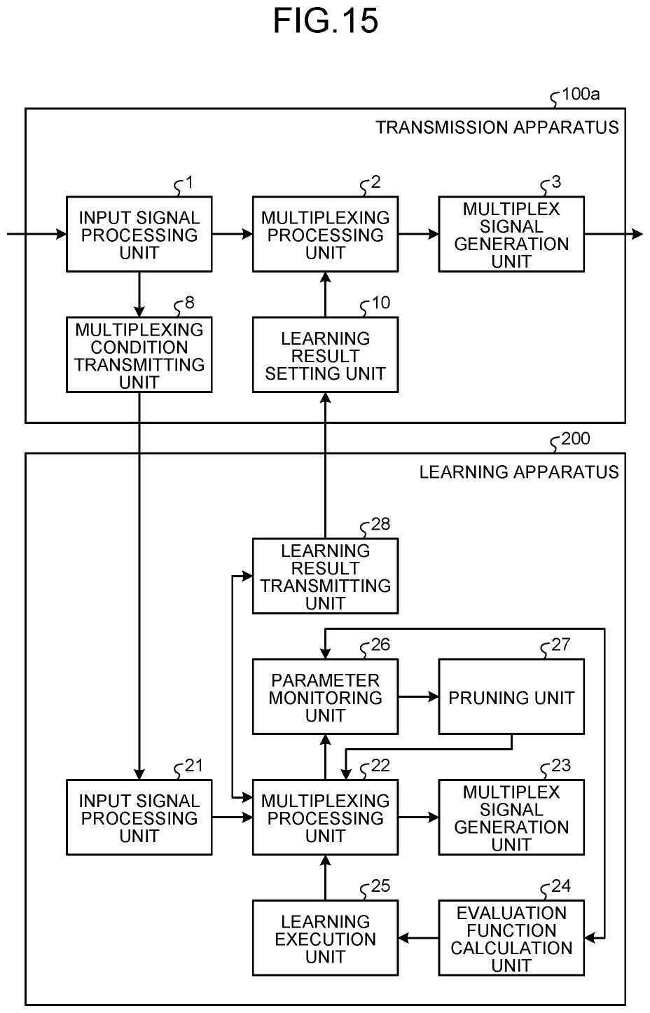

FIG. 15 is a diagram illustrating a functional configuration example of a transmission apparatus 100a and a learning apparatus 200 according to a second embodiment.

The transmission apparatus 100a according to the present embodiment includes the input signal processing unit 1, the multiplexing processing unit 2, the multiplex signal generation unit 3, a multiplexing condition transmitting unit 8, and a learning result setting unit or circuit 10. The input signal processing unit 1, the multiplexing processing unit 2, and the multiplex signal generation unit 3 of the transmission apparatus 100a are components that perform the same processing as the input signal processing unit 1, the multiplexing processing unit 2, and the multiplex signal generation unit 3 of the transmission apparatus 100 according to the first embodiment, and thus details of the processing will not be described.

The learning apparatus 200 includes an input signal processing unit 21, a multiplexing processing unit or processor 22, a multiplex signal generation unit or generator 23, an evaluation function calculation unit or calculator 24, a learning execution unit or circuit 25, a parameter monitoring unit or monitor 26, a pruning unit or circuit 27, and a learning result transmitting unit 28. The input signal processing unit 21, the multiplexing processing unit 22, the multiplex signal generation unit 23, the evaluation function calculation unit 24, the learning execution unit 25, the parameter monitoring unit 26, and the pruning unit 27 of the learning apparatus 200 are components that perform substantially the same processing as the input signal processing unit 1, the multiplexing processing unit 2, the multiplex signal generation unit 3, the evaluation function calculation unit 4, the learning execution unit 5, the parameter monitoring unit 6, and the pruning unit 7 of the transmission apparatus 100 according to the first embodiment, and thus details of that processing will not be described.

The following describes differences from the first embodiment.

The multiplexing condition transmitting unit 8 of the transmission apparatus 100a reads a constraint condition on each signal to be multiplexed from the input signal processing unit 1, and transmits the constraint conditions to the input signal processing unit 21 of the learning apparatus 200. A means by which the multiplexing condition transmitting unit 8 transmits the constraint conditions has a typical configuration and is substantially the same as a conventional one, and thus a detailed description thereof will be omitted.

The learning result transmitting unit 28 of the learning apparatus 200 reads parameters of the learned NN from the multiplexing processing unit 22 and transmits the parameters to the learning result setting unit 10 of the transmission apparatus 100a. The parameters of the NN transmitted at this time are parameters of the NN that has been subjected to the pruning processing. It is noted that a means by which the learning result transmitting unit 28 transmits the parameters of the NN has a typical configuration and is substantially the same as a conventional one, and thus a detailed description thereof will be omitted.

The learning result setting unit 10 of the transmission apparatus 100a receives parameters of the learned NN from the learning result transmitting unit 28 of the learning apparatus 200, and writes the received parameters into the NN of the multiplexing processing unit 2.

Next, the operation of the transmission apparatus 100a will be described. In the present embodiment, even in the case where the computer resources of the transmission apparatus 100a have been exhausted and learning cannot be performed onboard, computer resources of the learning apparatus 200 that is another piece of equipment are used to learn the parameters of the NN suitable for the signal multiplexing processing, and further the pruning processing is performed, thereby to optimize the NN used by the multiplexing processing unit 2.

Details of the operation of the transmission apparatus 100a will be divisionally described for each of sections categorized by a learning step, a pruning step, and an operating step as in the first embodiment. However, some operation common to the first embodiment will be omitted in description.

<Learning Step >

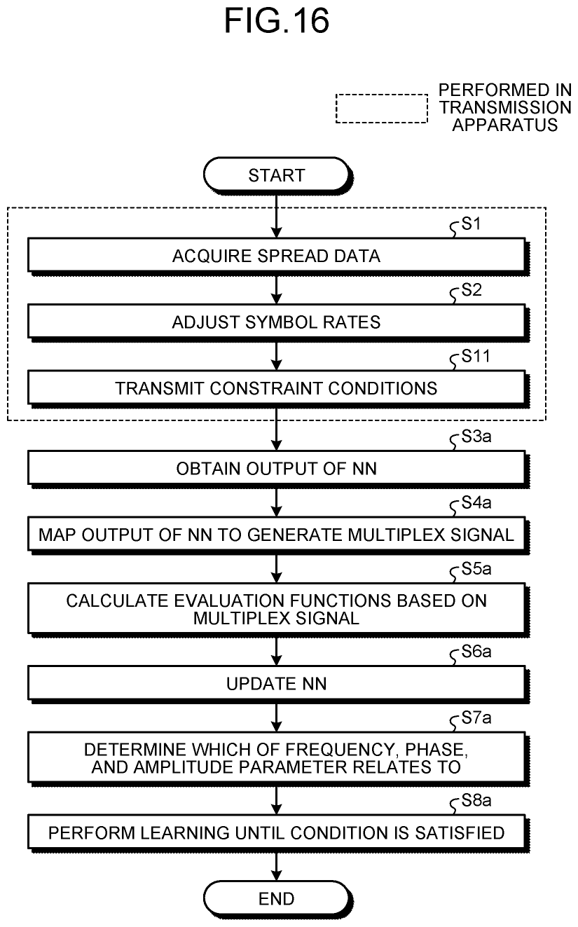

FIG. 16 is a flowchart illustrating an example of operation when the transmission apparatus 100a and the learning apparatus 200 according to the second embodiment perform the learning step. The same operation as in the first embodiment will not be described. A part enclosed by a broken line in FIG. 16 refers to an operation carried out in the transmission apparatus 100a, and the other part refers to an operation carried out in the learning apparatus 200.

Steps S1 and S2 of the flowchart illustrated in FIG. 16 define the same processing as steps S1 and S2 of the flowchart of FIG. 5 illustrating the operation in the first embodiment. In addition, steps S3a to S8a of the flowchart illustrated in FIG. 16 define processing similar to that of steps S3 to S8 of the flowchart illustrated in FIG. 5, but are different in that steps S3a to S8a are executed in the learning apparatus 200. Description of these steps S1, S2, and S3a to S8a will be omitted.

After the input signal processing unit 1 adjusts the symbol rates of the spread data in step S2, the multiplexing condition transmitting unit 8 acquires constraint conditions on the signals to be multiplexed from the input signal processing unit 1 and transmits the constraint conditions to the input signal processing unit 21 of the learning apparatus 200 (step S11). An example of the constraint conditions to be transmitted by the multiplexing condition transmitting unit 8 is the transmission power ratio and the phase of each signal to be multiplexed by the multiplexing processing unit 2, which are illustrated in FIG. 6. For example, the constraint conditions are written in a memory of the multiplexing condition transmitting unit 8 and subjected to data compression, and thereafter transmitted from the transmission apparatus 100a to the learning apparatus 200 via antennas provided to both of the apparatuses by wireless communication.

The learning apparatus 200 performs steps S3a to S8a using the constraint conditions received in step S11 to thereby perform learning of the NN, that is, update of the NN parameters.

<Pruning Step >

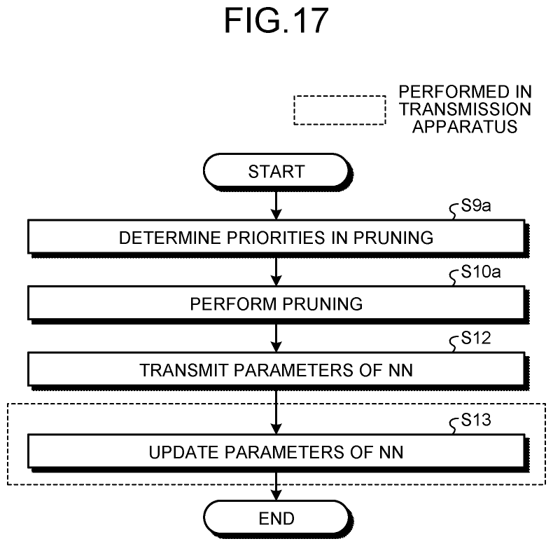

FIG. 17 is a flowchart illustrating an example of operation when the transmission apparatus 100a and the learning apparatus 200 according to the second embodiment perform the pruning step. Substantially the same operation as in the first embodiment will not be described. A part enclosed by a broken line in FIG. 17 refers to an operation carried out in the transmission apparatus 100a, and the other part refers to an operation carried out in the learning apparatus 200.

Steps S9a to S10a of the flowchart illustrated in FIG. 17 refer to processing similar to that of steps S9 to S10 of the flowchart illustrated in FIG. 12, but are different in that steps S9a to S10a are performed in the learning apparatus 200. Description of these steps S9a to S10a will be omitted.

After steps S9a and S10a are performed in the learning apparatus 200, the learning result transmitting unit 28 transmits the parameters of the NN to the transmission apparatus 100a (step S12). A procedure of the learning result transmitting unit 28 transmitting the NN parameters is substantially the same as a procedure of the multiplexing condition transmitting unit 8 of the transmission apparatus 100a transmitting the constraint conditions on the signals, and thus will not be described.

Upon receiving the NN parameters transmitted by the learning result transmitting unit 28 of the learning apparatus 200, the learning result setting unit 10 of the transmission apparatus 100a updates the parameters of the NN constituting the multiplexing processing unit 2, in accordance with the received NN parameters (step S13). This processing can completely match the NN parameters of the multiplexing processing unit 22 of the learning apparatus 200 with the NN parameters of the multiplexing processing unit 2 of the transmission apparatus 100a, and both of the former parameters and the latter parameters can provide a possibility to generate the same multiplex signal.

<Operating Step >

An operation in the operating step in which the transmission apparatus 100a generates a multiplex signal using the learned NN is the same as that in the first embodiment, and thus its description will be omitted.

As described above, the transmission apparatus 100a according to the second embodiment transmits constraint conditions on signals to be multiplexed to the learning apparatus 200 situated externally, and the learning apparatus 200 performs learning based on the received constraint conditions and updates the parameters of the NN that are used to multiplex the signals. Further, the learning apparatus 200 performs pruning and transmits obtained learning results, specifically, the parameters of the NN to the transmission apparatus 100a. The transmission apparatus 100a updates the parameters of the NN of the multiplexing processing unit 2 on the basis of the learning results in the learning apparatus 200. By doing so, even if the computer resources of the transmission apparatus 100a have been exhausted, and learning cannot be performed onboard, the parameters of the NN of the multiplexing processing unit 2 can be updated, and the effects similar to those of the transmission apparatus 100 according to the first embodiment can be achieved.

In the configuration illustrated in FIG. 15, constraint conditions are transmitted from the transmission apparatus 100a to the learning apparatus 200, but the learning apparatus 200 may hold the constraint conditions in advance.

The transmission apparatus according to the present disclosure achieves an advantageous effect that it can restrain performance degradation caused when the amount of calculation of the neural network used for signal multiplexing is reduced by the pruning operation.

The configurations described in the above embodiments illustrate just examples and can be combined with other publicly known techniques. Besides, the embodiments can be combined with each other, and each of the configurations can be partly omitted and/or modified without departing from the scope of the present disclosure.

1. A transmission apparatus, comprising:
a multiplex signal generator to generate a multiplex signal based on multiplexed data into which two or more pieces of data are multiplexed; and
a multiplexing processor to generate the multiplexed data by multiplexing the pieces of data using a neural network whose parameters have been adjusted based on constraint conditions defined by an amplitude of the multiplex signal and a phase difference among the two or more pieces of data included in the multiplex signal, wherein
the neural network has undergone pruning based on updates of parameters and a multiplex signal generated based on the multiplexed data generated using the parameters updated.

2. The transmission apparatus according to claim 1, wherein
the multiplexing processor multiplexes N (N is two or more) pieces of data each having one of M values (M is two or more) using the neural network to generate the multiplexed data represented by M^{N} signal points.

3. The transmission apparatus according to claim 1, comprising:
a parameter monitor to monitor updates of the parameters of the neural network and the multiplex signal generated based on the multiplexed data generated using the updated parameters, and determine which of frequency, phase, or amplitude of the multiplex signal each parameter of the neural network relates to; and
a pruning circuit to perform pruning on the neural network based on results of the determination performed by the parameter monitor.

4. The transmission apparatus according to claim 1, comprising:
an evaluation function calculator to calculate an evaluation function for the neural network, based on the constraint conditions and the multiplex signal; and
a learning execution circuit to update the parameters of the neural network based on the evaluation function.

5. The transmission apparatus according to claim 1, comprising:
a learning result setting circuit to acquire parameters of a neural network that has been subjected to adjustment of the parameters and pruning by a learning apparatus from the learning apparatus, and update the parameters of the neural network included in the multiplexing processor, in accordance with the acquired parameters.

6. A transmission method, comprising:
a first step of generating a multiplex signal based on multiplexed data into which a plurality of pieces of data is multiplexed; and
a second step of generating the multiplexed data by multiplexing the plurality of pieces of data using a neural network whose parameters have been adjusted based on constraint conditions defined by an amplitude of the multiplex signal and a phase difference among the plurality of pieces of data included in the multiplex signal, wherein
the neural network has undergone pruning based on updates of parameters and a multiplex signal generated based on the multiplexed data generated using the parameters updated.

7. A control circuit to control a transmission apparatus to transmit a multiplex signal generated based on multiplexed data into which a plurality of pieces of data is multiplexed, the control circuit causing the transmission apparatus to perform
processing to generate the multiplexed data by multiplexing the plurality of pieces of data using a neural network whose parameters have been adjusted based on constraint conditions defined by an amplitude of the multiplex signal and a phase difference among the plurality of pieces of data included in the multiplex signal, wherein
the neural network has undergone pruning based on updates of parameters and a multiplex signal generated based on the multiplexed data generated using the parameters updated.

8. A storage medium in which a program is stored, the program being configured to control a transmission apparatus to transmit a multiplex signal generated based on multiplexed data into which a plurality of pieces of data is multiplexed, the program causing the transmission apparatus to perform
processing to generate the multiplexed data by multiplexing the plurality of pieces of data using a neural network whose parameters have been adjusted based on constraint conditions defined by an amplitude of the multiplex signal and a phase difference among the plurality of pieces of data included in the multiplex signal, wherein
the neural network has undergone pruning based on updates of parameters and the multiplex signal generated based on the multiplexed data generated using the parameters updated.

9. The transmission apparatus according to claim 2, comprising:
a parameter monitor to monitor updates of the parameters of the neural network and the multiplex signal generated based on the multiplexed data generated using the updated parameters, and determine which of frequency, phase, or amplitude of the multiplex signal each parameter of the neural network relates to; and
a pruning circuit to perform pruning on the neural network based on results of the determination performed by the parameter monitor.

10. The transmission apparatus according to claim 2, comprising:
an evaluation function calculator to calculate an evaluation function for the neural network, based on the constraint conditions and the multiplex signal; and
a learning execution circuit to update the parameters of the neural network based on the evaluation function.

11. The transmission apparatus according to claim 3, comprising:
an evaluation function calculator to calculate an evaluation function for the neural network, based on the constraint conditions and the multiplex signal; and
a learning execution circuit to update the parameters of the neural network based on the evaluation function.

12. The transmission apparatus according to claim 2, comprising:
a learning result setting circuit to acquire parameters of a neural network that has been subjected to adjustment of the parameters and pruning by a learning apparatus from the learning apparatus, and update the parameters of the neural network included in the multiplexing processor, in accordance with the acquired parameters.
